(19) United States
(12) Patent Application Publication
(10) Pub. No.: US 2023/0376827 A1
(43) Pub. Date: Nov. 23, 2023

(54) DYNAMIC GOAL OPTIMIZATION

(71) Applicant: International Business Machines Corporation, Armonk, NY (US)

(72) Inventors: Sebastian Carbajales, Mississauga (CA); Jose Adelino Gomes de Freitas, Hampshire (GB); SAMPATH DECHU, Bangalore (IN); Prerna Agarwal, New Delhi (IN)

(21) Appl. No.: 17/663,872

(22) Filed: May 18, 2022

(51) Int. Cl. G06N 20/00

(52) U.S. Cl. CPC G06N 20/00

(57) ABSTRACT

Embodiments of the present invention provide computer-implemented methods, computer program products and computer systems. Embodiments of the present invention enrich received information based on identified attributes. Embodiments of the present invention can then dynamically generate a recommendation that satisfies a goal based, at least in part on the enriched information. Embodiments of the present invention can then execute at least one dynamically generated goal that satisfies the goal.

### BACKGROUND

The present invention relates generally to the field of automated systems, and more particularly to dynamic optimization of conversational process automation systems.

In traditional workflow automation tools, a software developer produces a list of actions to automate a task and interface to the back-end system using internal application programming interfaces (APIs) or dedicated scripting language. Conversational Process Automation (CPA) typically allows a business and its contact center to be more agile, more adaptive to business-specific demands, and able to increase both customer and employee satisfaction. Generally, CPA provides a seamless integration of processes and conversations which allows for large percentages of customer service queries to be processed without any human involvement. Because the CPA engine is powered by Application programming interfaces (APIs), it can seamlessly connect the intent of the customer to the back-end systems required for case resolution, without agent involvement. What the contact center manager sees in their customer relationship management (CRM) and the CPA system's dashboard are automatically resolved tickets with corresponding Customer Satisfaction Score (CSAT) scores, which are typically much higher than they were before.

### SUMMARY

According to an aspect of the present invention, there is provided a computer-implemented method. The computer implemented method comprises: enriching received information based on identified attributes; dynamically generating a recommendation that satisfies a goal based, at least in part on the enriched information; and executing at least one dynamically generated goal that satisfies the goal.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps for dynamically generating optimized recommendations, in accordance with an embodiment of the present invention in accordance with an embodiment of the present invention;

FIG. 3 depicts an example process log with conversation, in accordance with an embodiment of the present invention;

FIG. 4 depicts an example enriched log, in accordance with an embodiment of the present invention; and

FIG. 5 is a block diagram of an example system, in accordance with an embodiment of the present invention.

### DETAILED DESCRIPTION

Typically, in an enterprise setting, (e.g., in many business or IT processes), human agent seeks advice from agent assist bots for next best action which may be asking more information from the customer or actions to take on Enterprise Resource Planning (ERP) systems or queries for more information from ERP. Existing recommendation systems train agent assist bots for a “next best action.” Typically, these systems are optimized for agent centric goals such as accurate answers for questions from customer, efficient resolution of a ticket using prior knowledge, or guide user towards a goal of purchasing a product. In enterprise settings, there are organizational goals for processes which are monitored by tracking specific Key Performance Indicators (KPIs) at a process level (as opposed to single case level).

Currently, embodiments of the present invention recognize that there are no existing systems which recommends next best action (including utterance) to an agent towards a direction that meets organization goals at an aggregate. Some example goals can include: improve Net Promotor Score (NPS), for example, customer satisfaction, by 10%, reduce fraud leakage by 25%, reduce the process cost by 20%, improve the process efficiency by 25%. Organization goals are typically weighted metric across the multiple of specific goals and these goals change dynamically depending on quarterly goals or current state of customers etc. Accordingly, embodiments of the present invention recognize there is a need for an action recommendation system that is aware of and optimized for the goals that are set at organization level and makes recommendations to agents such that the organizational goals are met in aggregate. As such, embodiments of the present invention provide an action recommendation system that is customizable (e.g., tunable) by a business persona according to the dynamic changes in organizational goals without need to retrain the entire system again, as discussed in greater detail later in this Specification.

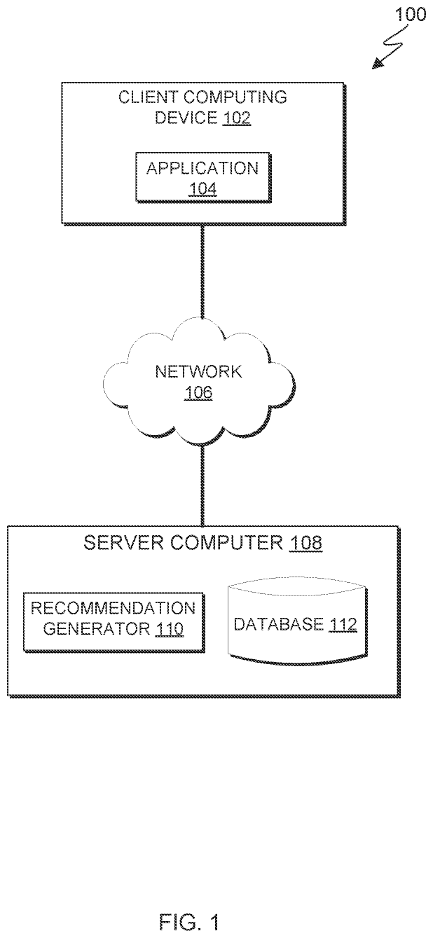

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

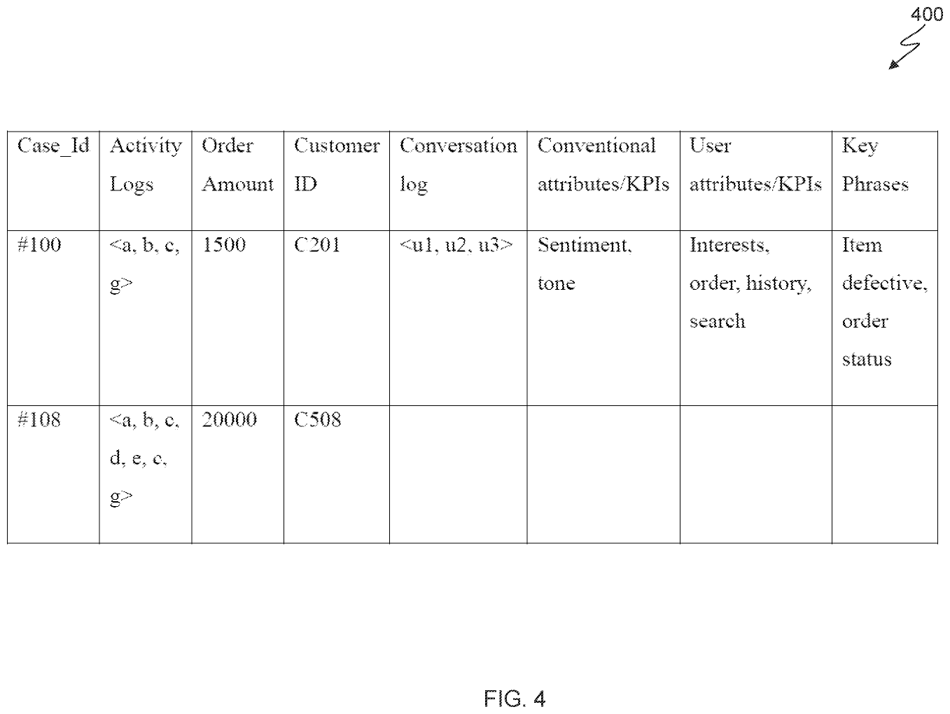

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computers as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 4.

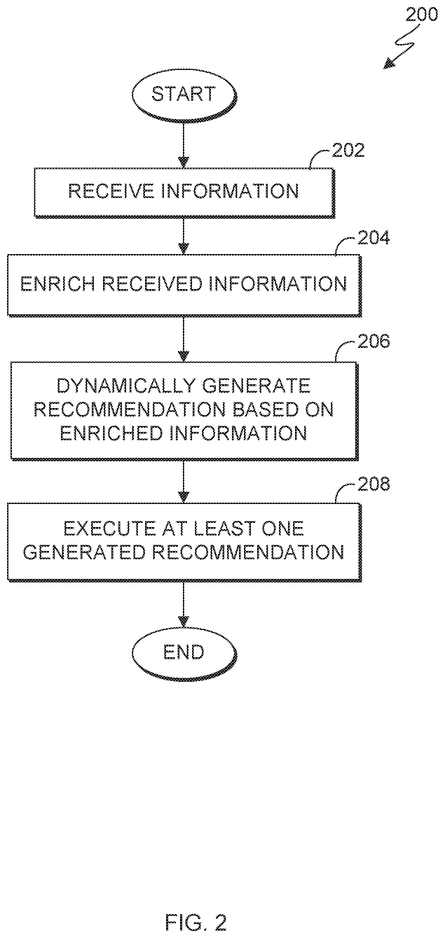

In this embodiment, client computing device 102 is a user device associated with a user and includes application 104. Application 104 communicates with server computer 108 to access recommendation generator 110 (e.g., using TCP/IP) to access user information and database information. Application 104 can further communicate with recommendation generator 110 dynamically generate one or more recommendations that are optimized based on comprehensive organizational goals, as discussed in greater detail in FIG. 2.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts recommendation generator 110 and database 112. In this embodiment, recommendation generator 110 resides on server computer 108. In other embodiments, recommendation generator 110 can have an instance of the program (not shown) stored locally on client computer device 102. In other embodiments, recommendation generator 110 can be a standalone program or system that can be integrated in one or more computing devices having a display screen.

Recommendation generator 110 can dynamically generate one or more recommendations that are optimized based on comprehensive organizational goals. Recommendation generator 110 can be integrated into a recommendation system to recommend a set of next best actions that are optimized for dynamic comprehensive organizational goals to a process agent executing a business process interleaved with conversations with a user. In some embodiments, recommendation generator 110 can be integrated into the recommendation system to automatically recommend next base actions based on dynamic comprehensive organizational goals and user interaction without process agent (e.g., user intervention). Recommendation generator 110 dynamically generates one or more recommendations by selecting a maximal subset of instances of historical data that, in aggregate achieves a threshold level of satisfaction for an elemental goal requirement that is a part of the comprehensive organizational goal. Additionally, recommendation generator 110 can also select a maximal subset of next best action recommendations which satisfy at least one comprehensive organization goal based on a function of user-specified weighted federated recommendations from multiple elemental goal optimized recommendation models.

In general, recommendation generator 110 can receive information from one or more databases. Information received or otherwise accessed by recommendation generator 110 can include organization goals (e.g., KPIs, reduce fraud leakage, reduce the process cost, improve the process efficiency, etc.), historical logs (e.g., human to human chat logs, process execution logs, process logs with conversations etc.), and user data. In this embodiment, user data refers to data generated by one or more user actions and can include user information, device specific information, and case data. Information received can also include particularly executed traces. In another embodiment, recommendation generator 110 can, with user informed consent monitor one or more user organizational goals, one or more historical logs, and user data.

In this embodiment, recommendation generator 110 can access conversational logs and process logs and enrich the accessed logs (e.g., perform log enrichment). In this embodiment, recommendation generator 110 can enrich the logs by identifying one or more key phrases, conversational attributes and one or more user attributes using a combination of natural language processing (e.g., sentence splitting, tokenization, POS tagging, chunking, dependency parsing, and anaphora resolution, etc.) to process the semantics of the text and artificial intelligence algorithms. In other embodiments, recommendation generator 110 uses a machine learning training pipeline to identify conversational features, process-aware features, and business process attributes.

Recommendation generator 110 can then integrate the enriched conversational logs into respective process logs via a trace subset selector (not shown) and generate one or more recommendations. In this embodiment, recommendation generator 110 generates one or more recommendations based, at least in part, on a dynamic comprehensive satisfaction goal. In this embodiment, the dynamic comprehensive satisfaction goal is a function of an aggregate of elemental goals. For example, a comprehensive satisfaction goal could focus on increasing customer satisfaction. Elemental goals of that comprehensive satisfaction goal can include KPIs, reduce fraud leakage, reduce the process cost, improve the process efficiency, etc.

In some embodiments, recommendation generator 110 can dynamically calculate and readjust weighted values of each of the elemental goals in order to satisfy the dynamic comprehensive satisfaction goal. In this embodiment, recommendation generator 110 can compute individual goal values for each received case (e.g., find maximum subset of traces using Integer Linear Programming) as discussed in greater detail with respect to FIGS. 2-4. In this way, recommendation generator can select a maximal subset of instances (e.g., cases) of historical data that, in aggregative achieves a threshold satisfaction level for an elemental goal requirement. By selecting actions that satisfy the threshold satisfaction level for each elemental goal requirements, recommendation generator 110 can ensure the dynamic comprehensive satisfaction goal of a respective organization is achieved.

Recommendation generator 110 can then generate one or more subsets (e.g., a maximal subset) of a “next best action” recommendation. In this embodiment, a “next best action” refers to an alternate, generated recommendation that can satisfy an elemental goal. A next best action can also refer to an action that can be automatically or manually performed by either a process (i.e., service agent) or end user) to satisfy a query. In this embodiment, recommendation generator 110 can generate and subsequently select a next best action recommendation based on the recommendation's ability to satisfy the dynamic comprehensive goal. In certain circumstances a next best action recommendation may be an action that may not be the most optimal solution for the specific goal but is an action that satisfies the dynamic comprehensive goal. For example, a next best action recommendation can suggest devoting computing power to reduce process time. A recommendation that satisfies that goal could be to devote 100% of resources to process a received task and thus reduce processing time of a request, however, this recommendation, if executed could negatively impact other received goals such as reducing process costs. Thus, in this manner, recommendation generator 110 can optimize recommendation for that satisfy the dynamic comprehensive goal as opposed to optimizing recommendations based solely on individually received goals. These recommendations of a next best action are generated as recommendations that satisfy the dynamic comprehensive organizational goal which is a function of user-specified weighted federated recommendations from multiple elemental goal optimized recommendation models. In some embodiments recommendation generator 110 can subsequently execute the selected recommendation that satisfies the dynamic comprehensive goal.

More specifically, in this embodiment, recommendation generator 110 performs trace subset selection for elemental goal model training utilizing historical conversational process with business attributes and user conversations and elemental goals. In this embodiment, elemental goals can be expressed as {G₁, G₂, . . . , Gₙ}. For each Goal, G₁, with defined goal criteria, recommendation generator 110 can extract key phrases from natural language utterances, conversational KPIs, user related attributes, activity related attributes from historical traces. In this way, recommendation generator 110 can enrich process logs with the above extracted attributes. Recommendation generator 110 then identifies a maximum subset of traces from process logs which satisfy the goal criteria of G₁. Finally, recommendation generator 110 obtains models {M₁, M₂, . . . , Mₙ.} corresponding to each elemental goal.

With respect recommendation subset selection that satisfies a dynamic comprehensive goal, recommendation generator 110 utilizes dynamic organization goal requirements (e.g., elemental goals, weights, and threshold level of satisfaction), partially executed traced, and trained elemental goal specific recommendation models (e.g., {M₁, M₂, . . . , Mₙ.}). In this way, recommendation generator 110 can output a set of recommendations for next best action that satisfies a dynamic comprehensive satisfaction goal. For example, recommendation generator 110 can obtain predictions (e.g., expressed as {R₁, R₂, . . . , Rₙ} from elemental goal specific recommendation models. Recommendation generator 110 can then define dynamic comprehensive satisfaction goal by defining relation between goals. Recommendation generator 110 can then find a maximum subset of recommendation which satisfy the dynamic comprehensive satisfaction goal to obtain the set of next best action recommendations (e.g., output expressed as {R₁, R₂, . . . , Rₖ}, where (k<=n).

Database 112 stores received information and can be representative of one or more databases that give permissioned access to recommendation generator 110 or publicly available databases. For example, database 112 can store received source material, depicted graphics, user interactions, user interfaces, functionalities associated with user interfaces, interaction components, etc. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting operational steps for dynamically generating optimized recommendations, in accordance with an embodiment of the present invention.

In step 202, recommendation generator 110 receives information. In this embodiment, recommendation generator 110 receives information from one or more databases (e.g., database 112). Information received or otherwise accessed by recommendation generator 110 can include organization goals (e.g., KPIs, reduce fraud leakage, reduce the process cost, improve the process efficiency, etc.), one or more historical logs (e.g., human to human chat logs, process execution logs, process logs with conversations, partially executed traces, fully executed traces, etc.), and user data (e.g., one or more user actions, user information, device specific information, case data, etc.). Information received can further include one or more organizational goals.

Recommendation generator 110 can then organize the received information to formulate a dynamic comprehensive goal by ordering each received organizational (e.g., elemental goal). In some embodiments, recommendation generator 110 can receive weighted values for each received organization goal.

In step 204, recommendation generator 110 enriches received information. In this embodiment, recommendation generator 110 can enriches the logs by identifying one or more key phrases, conversational attributes and one or more user attributes using a combination of natural language processing (e.g., sentence splitting, tokenization, POS tagging, chunking, dependency parsing, and anaphora resolution, etc.) to process the semantics of the text and artificial intelligence algorithms. In this embodiment, key phrases can be identified according to a database containing one or more words, phrases, combinations of words that has been designated as such. Conversational attributes, refers to one or more phrases indicated a status associated with a service or order (e.g., when, where, delivered, etc.).

In step 206, recommendation generator 110 dynamically generates recommendations based on enriched information. In this embodiment, recommendation generator 110 dynamically generates recommendations using a machine learning training pipeline. In some embodiments, recommendation generator 110 can place weighted values on received goals. In other embodiments, recommendation generator 110 can received weighted values for each goal of the received goals. Recommendation generator 110 can then compute individual goal values for each received case using the weighted values and enriched logs (which specifies conversational attributes, user attributes, respective KPIs, and key phrases). Recommendation generator 110 can then define an overall comprehensive goal (e.g., dynamic comprehensive satisfaction goal) as an expression of the combined calculated goals.

Recommendation generator 110 can then build a machine learning model for the next best action recommendation based on the dynamic comprehensive satisfaction goals using the set of features extracted for each trace and actions taken in the past.

In step 208, recommendation generator 110 executes at least on generated recommendation. In this embodiment, recommendation generator 110 executes at least one generated recommendation by transmitting instructions to change one or more user settings (e.g., to increase performance). In some embodiments, recommendation generator 110 can alter one or more system settings to reduce processing time.

In yet other embodiments, recommendation generator 110 can transmit a comprehensive list of recommendations along with the selected recommendation to a user (e.g., system admin, service agent, etc.). In response to receiving a user selection, recommendation generator 110 can execute the selected user selection.

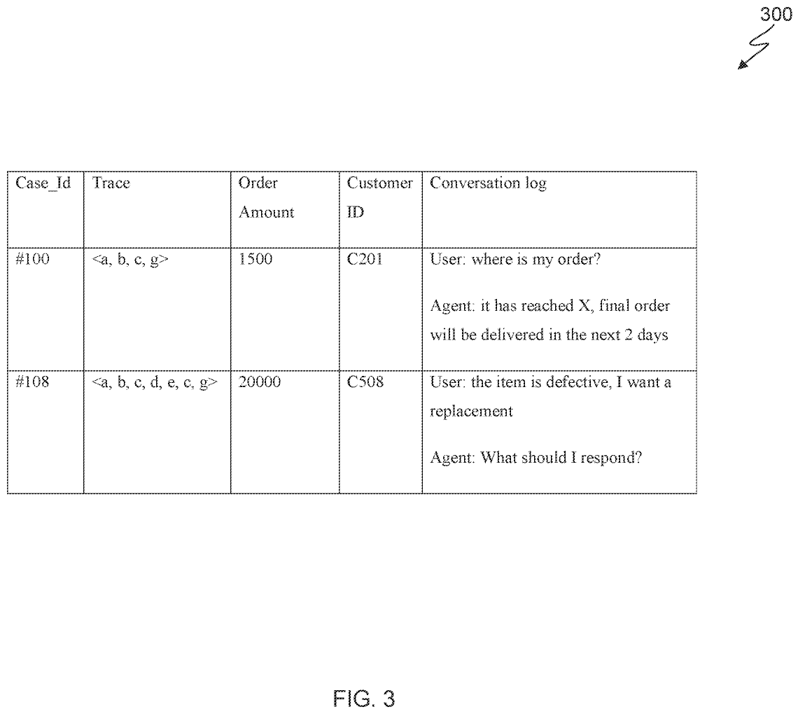

FIG. 3 depicts an example process log 300, in accordance with an embodiment of the present invention.

In this example, process log 300 (the example process log) includes user and case data. In this example, process log resembles a chart containing case identifiers (e.g., case Id), activity logs (e.g., traces, partially executed traces, etc.), order amount, customer identification numbers, and conversation logs. In this particular example, recommendation generator 110 can access two case IDs (e.g., #100 AND #108). In this example, recommendation generator 110 includes the following information for case ID 1 #100 (e.g., trace <a, b, c, g>, the order amount (e.g., 1500), customer ID (C201), and conversation log with the following dialogue, Example Dialogue 1:
User: where is my order?
Agent: it has reached X, final order will be delivered in the next 2 days
Example Dialogue 1.

In this example, recommendation generator 110 includes the following information for case ID 1 #108 (e.g., trace <a, b, c, d, e, c, g>, the order amount (e.g., 20000), customer ID (C508), and conversation log with the following dialogue, Example Dialogue 2:
User: the item is defective; I want a replacement.
Agent: What should I respond?
Example Dialogue 2.

Recommendation generator 110 can also access corresponding goals associated with The Example Process Log. In this example, corresponding goals (not shown) can include four goals: G₁ (reduce processing time), G₂ (reduce cost), G₃ (customer satisfaction), and G₄ (reduce defects). Recommendation generator 110 can compute individual goal values for each case (e.g., find maximum subset of traces using Integer Linear Programming. Specifically, recommendation generator 110 can use the following formula:

Max z=Σᵢ₌₁ⁿ(xᵢ) where (xᵢ)∈{0,1} Formula 1:

For example, for G₁ recommendation generator 110 can use Formula 1 to derive the score of 75.

$${G}_{1} = \frac{80 {x}_{1} + 65 {x}_{2} + … … + 70 {x}_{n}}{\sum {x}_{i}} = 75$$

For example, for G₂ recommendation generator 110 can use Formula 1 to derive the score of 40.

$${G}_{2} = \frac{52 {x}_{1} + 35 {x}_{2} + … … + 50 {x}_{n}}{\sum {x}_{i}} = 40$$

For example, for G₃ recommendation generator 110 can use Formula 1 to derive the score of 70.

$${G}_{3} = \frac{100 {x}_{1} + 85 {x}_{2} + … … + 75 {x}_{n}}{\sum {x}_{i}} = 70$$

For example, for G₄ recommendation generator 110 can use Formula 1 to derive the score of 35.

$${G}_{4} = \frac{1 {x}_{1} + 10 {x}_{2} + … … + 20 {x}_{n}}{\sum {x}_{i}} = 35$$

In this example, recommendation generator 110 can then extract conversational, process-aware, and related business attributes to build a machine learning model for a next best action recommendation for each of the previously described goals: G₁ (reduce processing time), G₂ (reduce cost), G₃ (customer satisfaction), and G₄ (reduce defects). In this example, recommendation generator 110 can use a set of features (e.g., conversational, process-aware, and related business attributes, etc.) extracted from each trace and actions taken in the past and obtain one recommendation model for each goal expressed as {R₁, R₂, . . . , Rₙ}. Recommendation generator 110 can then express the dynamic comprehensive satisfaction goals with the expression f(G₁, G₂, G₃, G₄).

In this example, a user can choose whether to optimize over a set of traces or on individual cases. Continuing this example where,

Max z=Σᵢ₌₁ⁿ(rᵢ) which satisfy DCS>=75,(rᵢ)∈{0,1} Example expression 1:

For individual trace: 80*0.4r₁+65*0.35r₂+ . . . +0.1*70rₙ>=75 Individual Trace:

For set of traces:

$$\frac{80 * 0.4 {r}_{i 1} + 65 * 0.35 {r}_{i 2} + … … + 0.1 * 70 {r}_{\dot{ι} n}}{\sum {r}_{i}} > = 75 ,$$

where i denotes each trace

FIG. 4 depicts an example enriched process log 400, in accordance with an embodiment of the present invention.

In this example, enriched process log 400 adds to process log 300 (discussed in FIG. 3). In this example, enriched process log 400 resembles a chart containing the information depicted in process log 300 such as case identifiers (e.g., case Id), activity logs (e.g., traces, partially executed traces, etc.), order amount, customer identification numbers, and conversation logs. In this example, enriched process log 400 adds the following metrics to the chart such as: conversational attributes/KPIs, user attributes/KPIs, and key phrases.

In this example, recommendation generator 110 can access corresponding goals (not shown for case ID #100 and 108 and calculates the goal values for four goals, G₁₋₄ to be 80, 52, 100, and 1 respectively for case id #100 after factoring in the additional key metrics added in the enriched process log and recalculated the values for four goals, G₁₋₄ to be 65, 35, 85, and 10 respectively for case id #108.

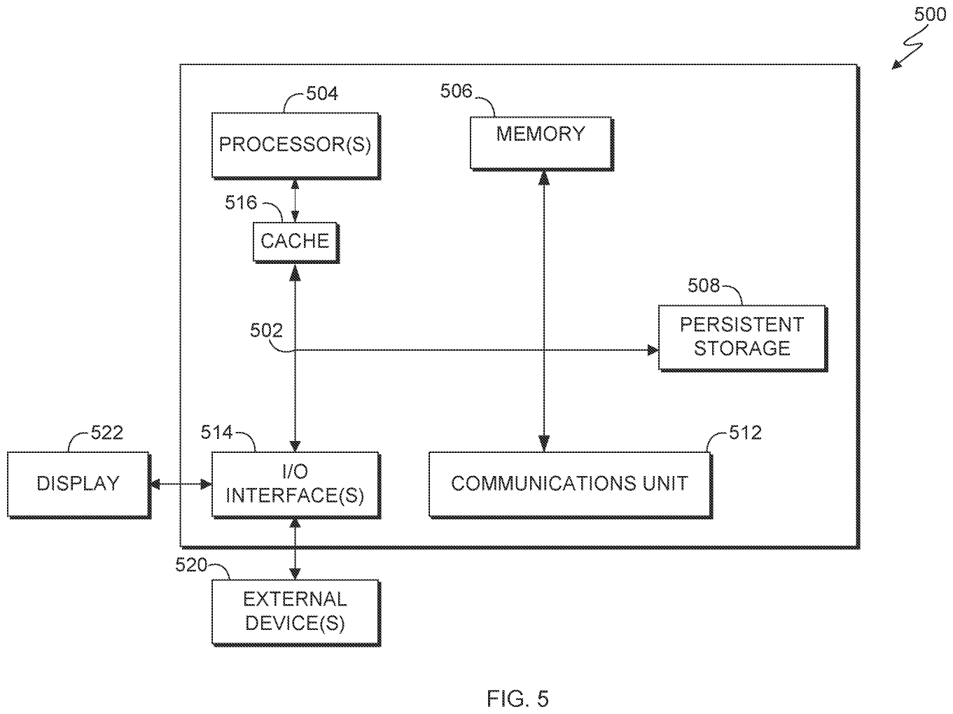

FIG. 5 depicts a block diagram of components of computing systems within computing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Recommendation generator 110 (not shown) may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links. Recommendation generator 110 may be downloaded to persistent storage 508 through communications unit 512.

I/O interface(s) 514 allows for input and output of data with other devices that may be connected to client computing device and/or server computer. For example, I/O interface 514 may provide a connection to external devices 520 such as a keyboard, keypad, a touch screen, and/or some other suitable input device. External devices 520 can also include portable computer readable storage media such as, for example, thumb drives, portable optical or magnetic disks, and memory cards. Software and data used to practice embodiments of the present invention, e.g., recommendation generator 110, can be stored on such portable computer readable storage media and can be loaded onto persistent storage 508 via I/O interface(s) 514. I/O interface(s) 514 also connect to a display 522.

Display 522 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
enriching received information based on identified attributes;
dynamically generating a recommendation that satisfies a goal based, at least in part on the enriched information; and
executing at least one dynamically generated goal that satisfies the goal.

2. The computer-implemented method of claim 1, wherein enriching received information based on identified attributes comprises:
identifying conversational attributes and user attributes associated with a case.

3. The computer-implemented method of claim 1, wherein dynamically generating a recommendation that satisfies a goal based, at least in part on the enriched information comprises:
selecting a maximal subset of instances of historical data that, in aggregate, achieves a threshold level for satisfaction of the goal.

4. The computer-implemented method of claim 3, further comprising:
building a machine learning model for a next best action recommendation by extracting conversational and process-aware attributes/

5. The computer-implemented method of claim 4, further comprising:
selecting a maximal subset of next best action recommendations using the built machine learning model that achieves a threshold level for the goal.

6. The computer-implemented method of claim 5, further comprising:
in response to receiving subsequent information, enriching the received information based on respective identified attributes; and
expressing a dynamic comprehensive satisfaction goal as a function of each received goal.

7. The computer-implemented method of claim 3, wherein the goal is a function of user specified weighted federated recommendations from multiple goal-optimized recommendation models.

8. A computer program product comprising:
one or more computer readable storage media and program instructions stored on the one or more computer readable storage media, the program instructions comprising:
program instructions to enrich received information based on identified attributes;
program instructions to dynamically generate a recommendation that satisfies a goal based, at least in part on the enriched information; and
program instructions to execute at least one dynamically generated goal that satisfies the goal.

9. The computer program product of claim 8, wherein the program instructions to enrich received information based on identified attributes comprise:
program instructions to identify conversational attributes and user attributes associated with a case.

10. The computer program product of claim 8, wherein the program instructions to dynamically generating a recommendation that satisfies a goal based, at least in part on the enriched information comprise:
program instructions to select a maximal subset of instances of historical data that, in aggregate, achieves a threshold level for satisfaction of the goal.

11. The computer program product of claim 10, wherein the program instructions stored on the one or more computer readable storage media further comprise:
program instructions to build a machine learning model for a next best action recommendation by extracting conversational and process-aware attributes.

12. The computer program product of claim 11, wherein the program instructions stored on the one or more computer readable storage media further comprise:
program instructions to select a maximal subset of next best action recommendations using the built machine learning model that achieves a threshold level for the goal.

13. The computer program product of claim 12, wherein the program instructions stored on the one or more computer readable storage media further comprise:
program instructions to, in response to receiving subsequent information, enrich the received information based on respective identified attributes; and
program instructions to express a dynamic comprehensive satisfaction goal as a function of each received goal.

14. The computer program product of claim 10, wherein the goal is a function of user specified weighted federated recommendations from multiple goal-optimized recommendation models.

15. A computer system comprising:
one or more computer processors;
one or more computer readable storage media; and
program instructions stored on the one or more computer readable storage media for execution by at least one of the one or more computer processors, the program instructions comprising:
program instructions to enrich received information based on identified attributes;
program instructions to dynamically generate a recommendation that satisfies a goal based, at least in part on the enriched information; and
program instructions to execute at least one dynamically generated goal that satisfies the goal.

16. The computer system of claim 15, wherein the program instructions to enrich received information based on identified attributes comprise:
program instructions to identify conversational attributes and user attributes associated with a case.

17. The computer system of claim 15, wherein the program instructions to dynamically generating a recommendation that satisfies a goal based, at least in part on the enriched information comprise:
program instructions to select a maximal subset of instances of historical data that, in aggregate, achieves a threshold level for satisfaction of the goal.

18. The computer system of claim 16, wherein the program instructions stored on the one or more computer readable storage media further comprise:
program instructions to build a machine learning model for a next best action recommendation by extracting conversational and process-aware attributes.

19. The computer system of claim 17, wherein the program instructions stored on the one or more computer readable storage media further comprise:
program instructions to select a maximal subset of next best action recommendations using the built machine learning model that achieves a threshold level for the goal.

20. The computer system of claim 18, wherein the program instructions stored on the one or more computer readable storage media further comprise:
program instructions to, in response to receiving subsequent information, enrich the received information based on respective identified attributes; and
program instructions to express a dynamic comprehensive satisfaction goal as a function of each received goal.
